(19) United States
(12) Patent Application Publication
(10) Pub. No.: US 2023/0188759 A1
(43) Pub. Date: Jun. 15, 2023

(54) Neural Network Assisted Removal of Video Compression Artifacts

(71) Applicant: Spectrum Optix Inc., Vancouver (CA)

(72) Inventors: Kevin Taylor Gordon, Edmonton (CA); Colin Thomas D'Amore, Edmonton (CA); Aidan Michael Earle, Edmonton (CA)

(21) Appl. No.: 18/064,754

(22) Filed: Dec. 12, 2022

Related U.S. Application Data
(60) Provisional application No. 63/289,454, filed on Dec. 14, 2021.

(51) Int. Cl. H04N 19/86; H04N 19/42; H04N 19/40

(52) U.S. Cl. CPC H04N 19/86; H04N 19/42; H04N 19/40

(57) ABSTRACT

A data compression system can include a neural compression artifact removal module (NCARM) is arranged to receive compressible data and output data with compression artifacts removed. A lossy compression module can be arranged to at least one of receive and send data to the NCARM and a decompression module arranged to at least one of receive and send data to the NCARM. In some embodiments, the NCARM sends data to the lossy compression module. Alternatively, the NCARM can receive data from the decompression module and/or data from the lossy compression module. Many lossy data compression schemes, including commonly available audio and video compression methods, can benefit from artifact removal.

### RELATED APPLICATION

This application claims the benefit of U.S. Provisional Application Ser. No. 63/289,454, filed Dec. 14, 2021, and entitled “Neural Network Assisted Removal of Video Compression Artifacts”, which is hereby incorporated by reference in its entirety.

### TECHNICAL FIELD

The present disclosure relates to systems for removal of lossy compression artifacts to improve image quality and reduce bandwidth requirements using neural networks.

### BACKGROUND

Data compression involves encoding information using fewer bits than an original representation. Typically, data compression is carried out in two discrete steps of encoding and decoding. During the encoding step, the input stream is transformed according to the compression scheme into a coded representation. During the decoding step the inverse transformation is applied, the coded representation is restored or nearly restored to the original input stream. A special case of data compression is transcoding, where data compressed in a first compression scheme is decoded and then recoded using an encoder from a second compression scheme.

Data compression can be either lossless or lossy. Lossless compression reduces bits of information by identifying and eliminating statistical redundancy. During lossless compression, no information is actually lost and all the bits from the original representation can be recovered during the decoding (decompression) process. In contrast, lossy compression does not retain all the bits of the original representation during encoding, but instead removes bits that are not useful or important according to some metric. This process can greatly reduce the overall number of bits, at a cost of quality degradation. Unfortunately, lossy compression can result in compression artifacts Examples compression artifacts include blocking artifacts, cosine or wavelet transform artifacts, quantization artifacts, aliasing artifacts, etc.

Digital image or video cameras typically require a digital image processing pipeline that converts signals received by an image sensor into a usable image by use of image processing algorithms and filters. Because of the large quantity of associated digital information, data encoding, decoding, and transcoding using lossy compression schemes are often used to support connections to streaming devices. What is needed are systems and methods for removal of lossy compression artifacts to improve image quality and reduce bandwidth.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates neural network assisted compression artifact removal before lossy compression and decompression;

FIG. 1B illustrates neural network assisted compression artifact removal after lossy compression and decompression;

FIG. 1C illustrates neural network assisted compression artifact removal after lossy compression and before decompression;

FIG. 2A illustrates a system and process for neural network assisted compression artifact removal and calibration;

FIG. 2B illustrates a lossy compression system and process for neural network assisted encoding and calibration;

FIG. 2C illustrates a lossy compression system and process for neural network assisted decoding and calibration;

FIG. 2D illustrates a lossy compression system and process for modifying high quality data streams using neural network assisted decoding and calibration;

FIG. 2E illustrates a system and process for neural network assisted decoding followed by neural network assisted compression artifact removal;

FIG. 2F illustrates a decoder system and process supporting neural network assisted compression artifact removal;

FIG. 2G illustrates an encoder system and process encompassing neural network assisted compression artifact removal;

FIG. 2H illustrates an encoder system and process encompassing neural network assisted compression artifact removal followed by encoding;

FIG. 2I illustrates a transcoding system and process encompassing neural network assisted compression artifact removal and combined decoding, followed by encoding;

FIG. 2J illustrates a transcoding system and process for decoding followed by neural network assisted compression artifact removal and combined encoding;

FIG. 2K illustrates a transcoding system and process for decoding, followed by neural network assisted compression artifact removal, and separate encoding;

FIG. 3A illustrates a multiple camera system supported by a transcoding system and process for neural network assisted compression artifact removal;

FIG. 3B illustrates a multiple camera system, with each camera supported by a transcoding system and process for neural network assisted compression artifact removal;

FIG. 3C illustrates cloud system including neural network assisted compression artifact removal encoding and decoding, and cloud storage; and

FIG. 3D illustrates a multiple user device system, with each user device supported by a decoding system and process for neural network assisted compression artifact removal.

### DETAILED DESCRIPTION

In some of the following described embodiments, methods, processing schemes, and systems for improving neural network (NN) processing are described. As will be disclosed in more detail, improved neural network processing encompasses a data compression system that can include a neural compression artifact removal module (NCARM) arranged to receive compressible data and output data with compression artifacts removed. A lossy compression module can be arranged to at least one of receive and send data to the NCARM and a decompression module arranged to at least one of receive and send data to the NCARM. In some embodiments, the NCARM sends data to the lossy compression module. Alternatively, the NCARM can receive data from the decompression module and/or data from the lossy compression module. As will be understood, while any lossy compressible data can be processed with the described system, in some embodiments the data is at least one of audio and video.

In other embodiments a data compression system can include a neural compression artifact removal module (NCARM) forming a portion of at least one of a transcoder and a lossy compression module, with the NCARM arranged to receive compressible data and output data with compression artifacts removed. A data encoder and decoder can be respectively connected to the NCARM and an NCARM calibration module arranged to at least one of receive and send data to the NCARM.

In other embodiments a data compression system can include a neural compression artifact removal module (NCARM) forming a portion of at least one of a transcoder, a lossy compression module, an encoding module, and a decoding module, with the NCARM arranged to receive compressible data and output data with compression artifacts removed. A data encoder and decoder can be respectively connected to the NCARM. A NCARM neural network forms a portion of one of the data encoder and decoder.

In another embodiment a camera data compression system can include a camera and a neural compression artifact removal module (NCARM) connected to the camera. The NCARM can be arranged to receive compressible data and output data with compression artifacts removed. In some embodiments the NCARM is operable on the camera, while in other embodiments the NCARM is operable on a cloud or VMS system that receives compressible data from the camera.

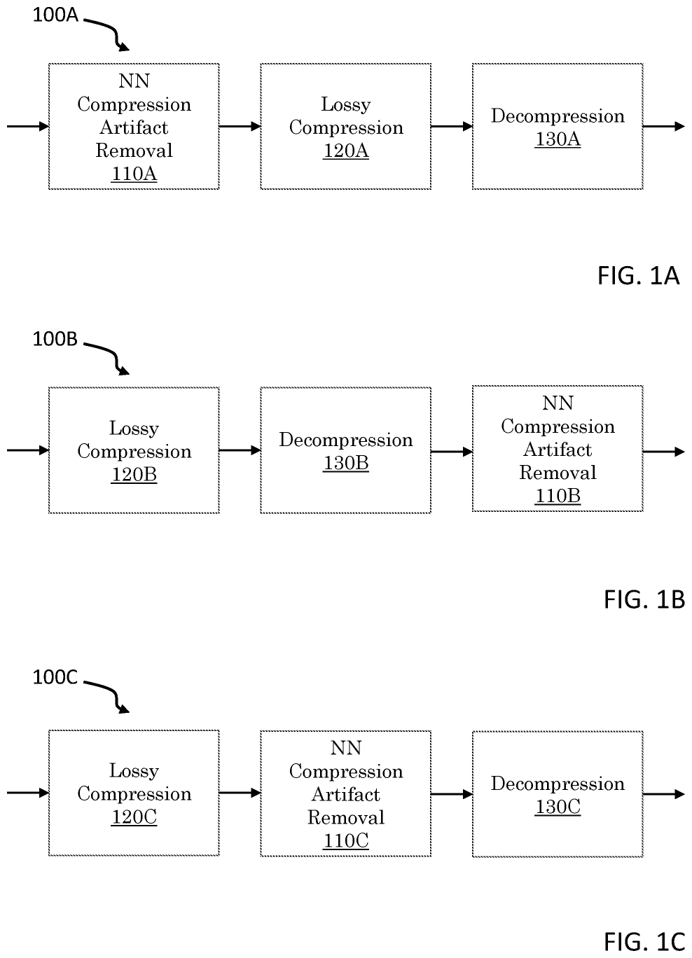

FIG. 1A illustrates neural network assisted compression artifact removal (NCARM) before lossy compression and decompression. In this embodiment, a system 100A receives data input that is first processed using a module 110A that provides neural network mediated compression artifact removal. The processed data is provided to a module 120A that provides lossy compression of the data. After storage, transmission, or streaming, a decompression module 130A can decode the compressed data and allow, for example, additional processing or playback by a user.

In one embodiment, data can include but is not limited to a wide range of video, audio, streaming, sensor, or control data. Lossy compression is often used in such applications in part because of their large input complexity, and also because of the high degree of redundancy in their data streams. Processing data according to this disclosure can benefit of image quality, reduced file size and bandwidth requirements, and give improved downstream machine or artificial intelligence (AI) application performance. In effect, lossy data compression reduces file size at the expense of some signal loss. In addition to signal loss, in many cases the compression process will also introduce undesirable artifacts. Using neural network technology allows partially recovery lost signals while also removing compression artifacts. The described systems and methods can improve signal fidelity and further reduces file size or bandwidth requirements, thereby enabling aggressive compression without compromising the original signal.

As will be understood, a wide variety of compression schemes can be used in the systems described in this disclosure. For example, both intra-frame (which use single frame image compression and interframe (which use one or more preceding and/or succeeding frames in a sequence to compress the contents of the current frame) video compression systems can benefit from neural network mediated artifact removal. Common compression schemes include but are not limited to Motion JPEG (M-JPEG), MPEG-1 (CD, VCD), MPEG-2 (DVD), MPEG-4, and H.264 based compression (encoding) and decompression (decoding) schemes.

In one embodiment, the module providing neural network assisted compression artifact removal (NCARM) services is a neural network that has been calibrated (trained) to remove input complexity and compression artifacts, while preserving data fidelity. In the case of images and video, the network receives as input images or a sequence of images, and outputs an enhanced image or sequence of images. Depending on system architecture, the NCARM processing module can be applied during the encoding phase, during the decoding phase, or during the transcoding phase. Further, the module can be standalone, or integrated with the decoder or encoder. In general, the processing submodule accepts as input an unencoded data stream and removes data complexity from the signal such that 1) the encoding process is more efficient with less artifacts, or 2) any artifacts resulting from the compression scheme are removed.

In some embodiments, calibration for the module providing neural network assisted compression artifact removal (NCARM) can be made using manual or automated parameters. This can be accomplished via training of the processing submodule's neural network (NN), whereby some loss function is minimized or maximized. In some embodiments a calibration module receives both the high-fidelity signal as well as the encoded-decoded signal that has been degraded. The calibration submodule adjusts the processing submodule's parameters such that much of the original high-fidelity signal is restored. In the absence of a “paired” high-fidelity/degraded signal, a reference high-quality stream can be used. In this case, the calibration submodule does not attempt to restore the degraded stream to an identical copy of the high-fidelity stream, but via methods such as generative-adversarial training attempts to match the statistical distribution of the degraded stream with that of the high-fidelity stream.

As will be understood, various embodiments of neural networks (NN) can be used. For example, neural networks can include fully convolutional, recurrent, generative adversarial, or deep convolutional networks. Convolutional neural networks are particularly useful for image processing applications such as described herein. Images can be pre-processed with conventional pixel operations or can preferably be fed with minimal modifications into a trained convolutional neural networks. Processing can proceed through one or more convolutional layers, pooling layers, a fully connected layer, and end with output suitable for encoding or decoding. In operation, one or more convolutional layers apply a convolution operation to the input, passing the result to the next layer(s). After convolution, local or global pooling layers can combine outputs into a single or small number of nodes in the next layer. Repeated convolutions, or convolution/pooling pairs are possible. After neural network processing is complete, the output can be passed between neural networks, to another local neural network, or in addition or alternatively to neural network based cloud based processing for additional neural network-based modifications.

One neural network embodiment of particular utility is a fully convolutional and recurrent neural network. A fully convolutional and recurrent neural network is composed of convolutional layers without any fully connected layers usually found at the end of the network. Advantageously, fully convolutional neural networks are image size independent, with any size images being acceptable as input for training or bright spot image modification. Recurrent behavior is provided by feeding at least some portion of output back into the convolutional layer or to other connected neural networks.

The various neural networks can identify and improve data compression for many types of artifacts. For example, capture noise originating from scene light and camera sensor is a common artifact. This noise is not caused by the encoding process but does contribute to the signal complexity (filesize/bandwidth) and quality. Capture noise can be divided into two cases: 1) low compression, where the noise is reasonably represented in the compressed video artifacts can be identified as “graininess”, and 2) high compression, where noise is poorly represented in the compressed video, and where it can be identified as irregular vertical or horizontal lines, or even checkerboards when viewed closely.

Many artifacts are due to representation by basis functions and use of quantization. Quantization noise is present because compression schemes often represent the data as a combination of basis functions (wavelet, discrete cosine, etc). In the limit, these can perfectly represent videos. However, many compression schemes reduce or remove the high frequency components since these don't significantly impact human perception. When aggressively compressing a signal, high frequency components appear as small patches of horizontal, vertical, or checkerboard patterns. These are the basis functions approximating the original signal with some error. Fortunately, such artifact errors can be corrected by use of neural networks and the described NCARM systems and methods.

Another type of artifacts known as blocking artifacts arise because many types of compression schemes aim to reuse as much information as possible. One way is to take a “patch” from the current or nearby frames and referencing it in multiple other areas. The patch is unlikely to perfect represent the other areas, so some error must be compensated for. In aggressive compression this error compensation is traded for filesize. After compression and decompression, resultant video data now includes small square patches in the video whose boundaries do not perfectly blend with its neighbors. Again, such artifact errors can be corrected by use of neural networks and the described NCARM systems and methods.

Another type of artifacts known as aliasing can also occur after compression and decompression. Aliasing is the result of limited spatial sampling period for a given signal jagged edges or moire patterns. Such artifact errors can be corrected by use of neural networks and the described NCARM systems and methods.

Artifacts can be automatically identified using machine intelligence techniques, or alternatively or in addition can be identified by a trained operator. The NCARM module can be trained to identify and remove these artifacts by ensuring they are well represented within the dataset. A team of data labelers can build a database of each artifact, which can be fed directly as training data to the NCARM module or used to train an automated “artifact classifier” algorithm which automates labelling of newly acquired data. Furthermore, for the purposes of training, these artifacts can be “forced” into the training data by purposefully using aggressive compression on some source material (modifying the input data or compression parameters such that the desired artifact becomes dominant).

FIG. 1B illustrates neural network assisted compression artifact removal after lossy compression and decompression. This embodiment can be considered a variation of that described with respect to FIG. 1A, with differing ordering of data processing by respective modules for neural network mediated compression artifact removal, lossy compression, and decompression. In this embodiment, a system 100B receives data input that is first processed using a module 120B that provides lossy compression of the data. The lossy compressed data is then provided to a decompression module 130B can decode the compressed data. Decompressed data can be provided to a module 110B that provides neural network mediated compression artifact removal.

FIG. 1C illustrates neural network assisted compression artifact removal after lossy compression and before decompression. This embodiment can be considered a variation of that described with respect to FIG. 1A, with differing ordering of data processing by respective modules for neural network mediated compression artifact removal, lossy compression, and decompression. In this embodiment, a system 100C receives data input that is first processed using a module 120C that provides lossy compression of the data. The lossy compressed data is then provided to a module 110C that provides neural network mediated compression artifact removal. This data can be provided to a decompression module 130A can decode the artifact removed and compressed data.

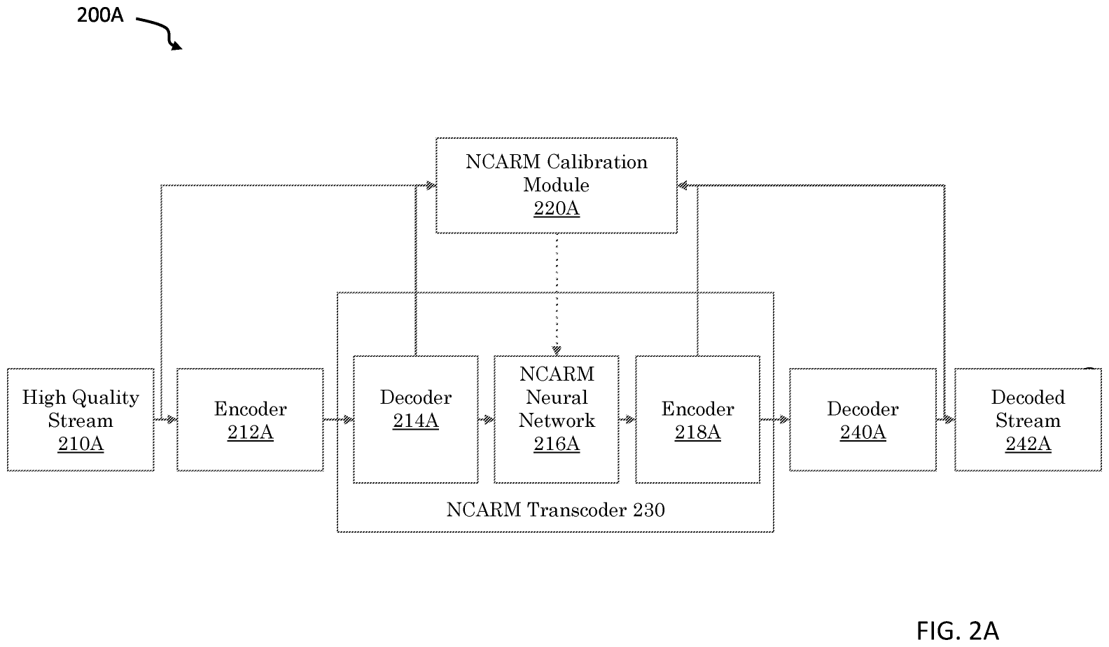

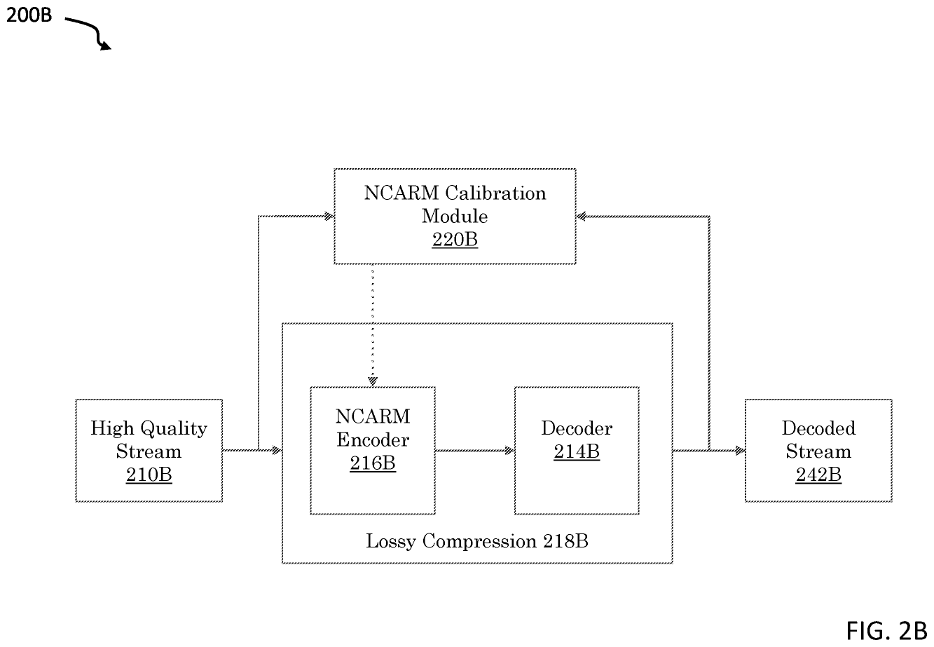

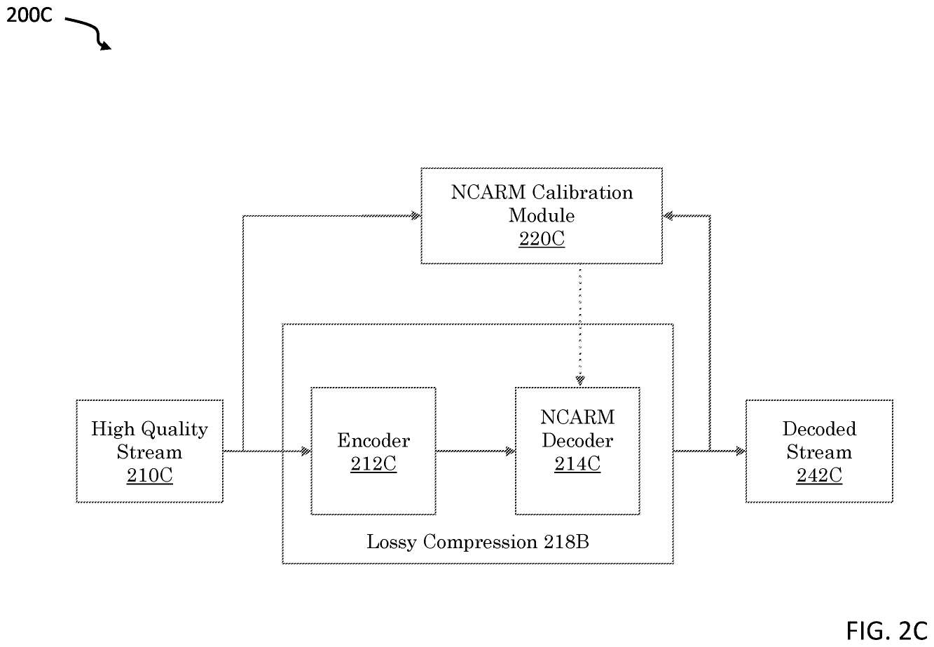

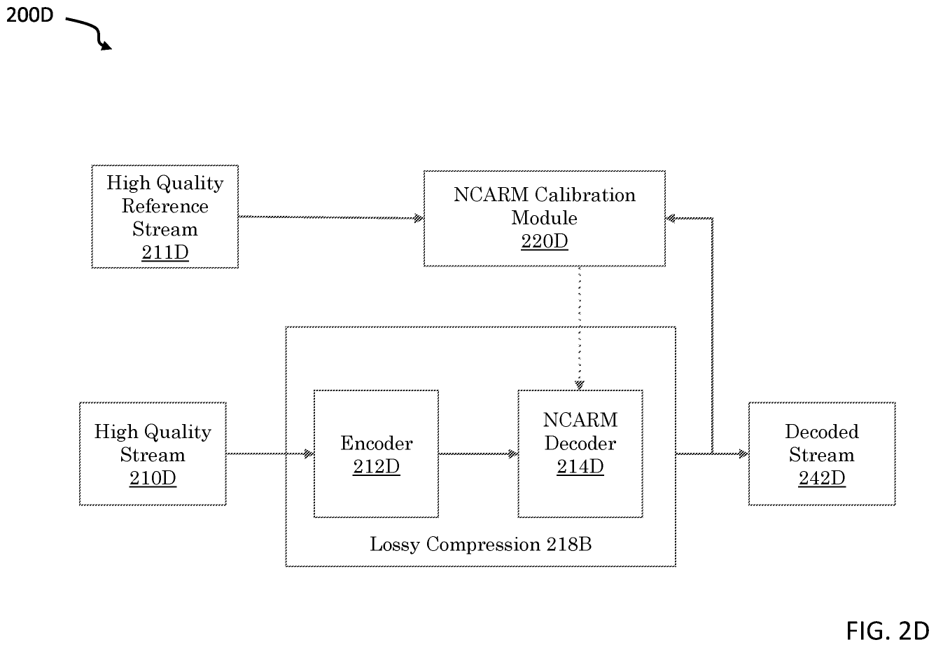

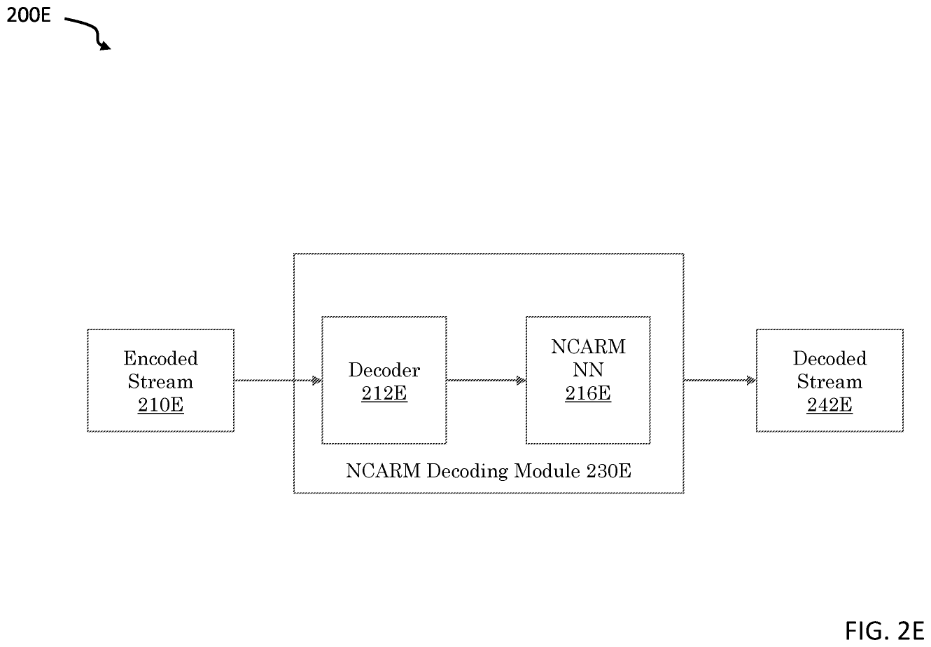

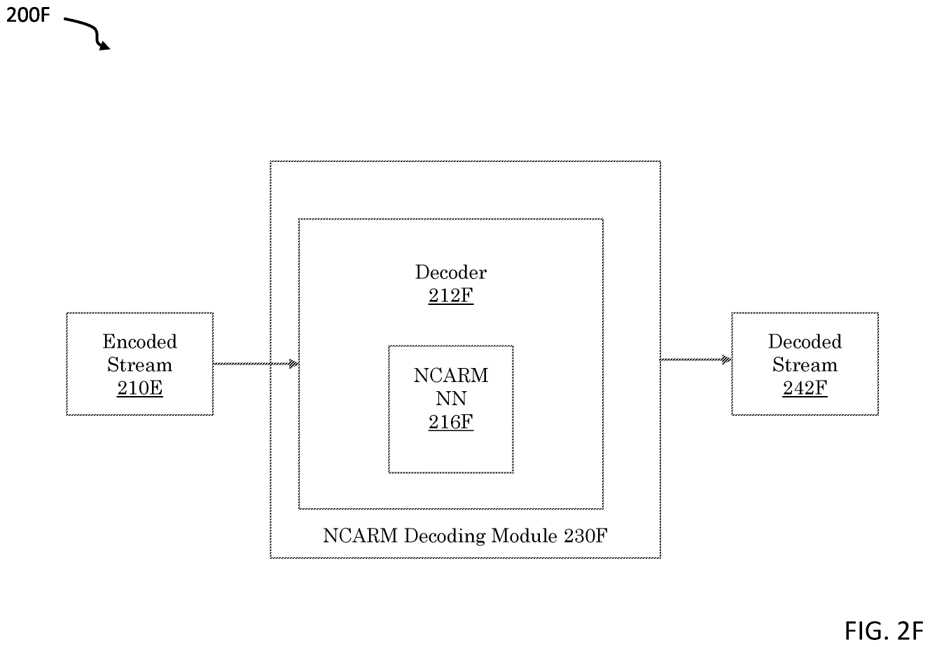

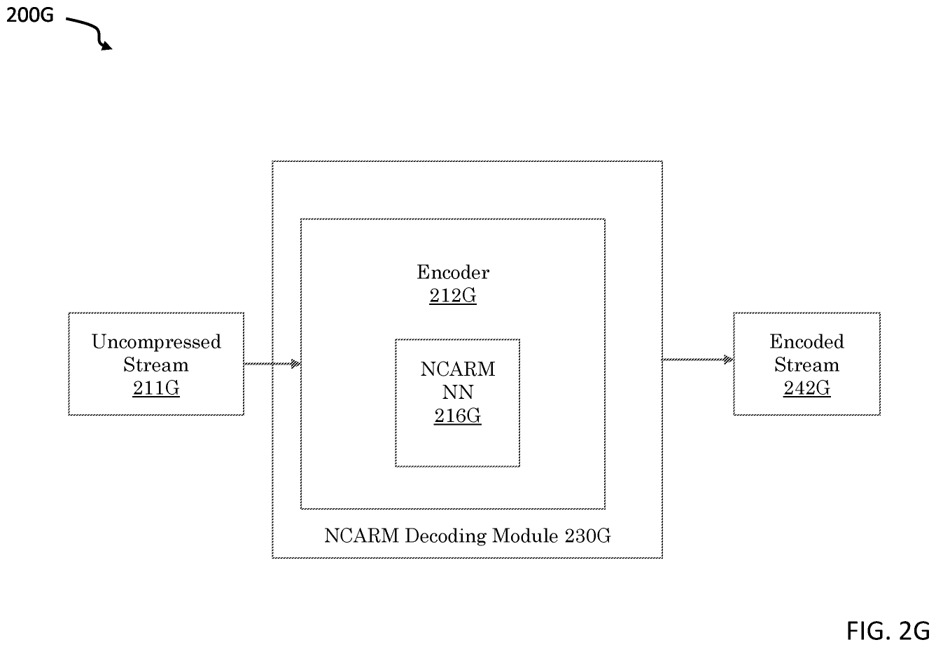

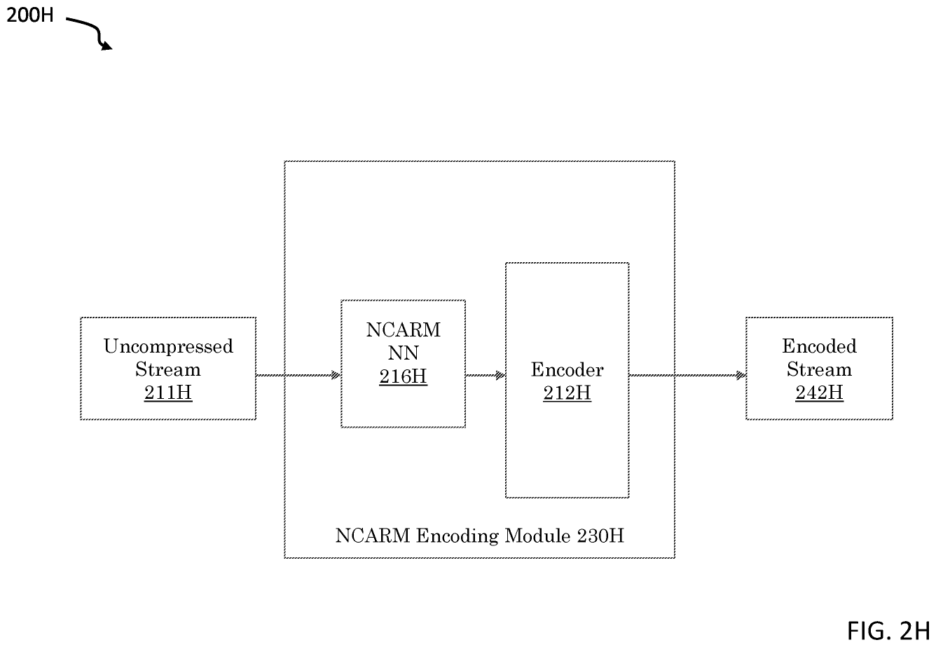

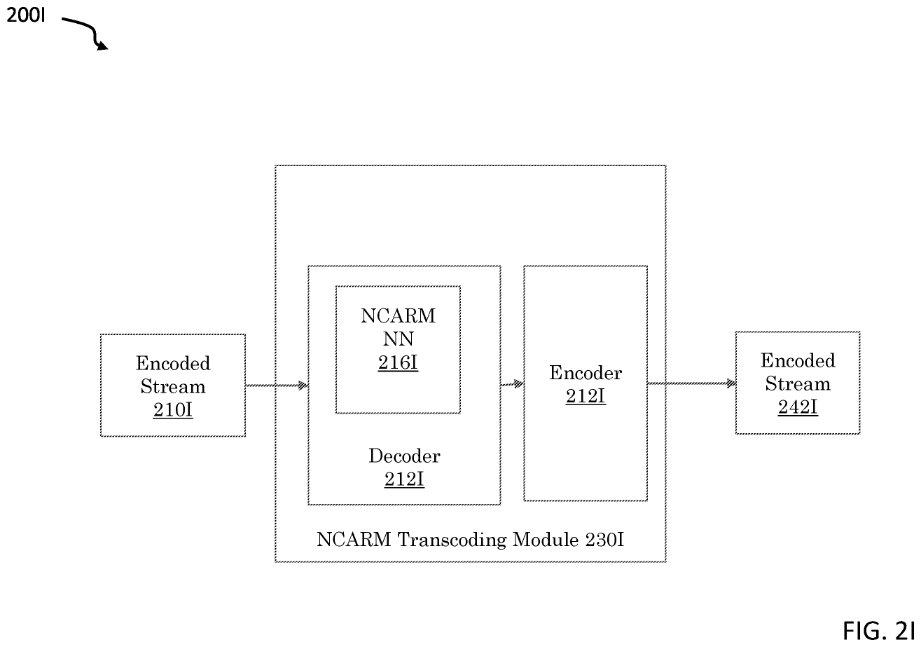

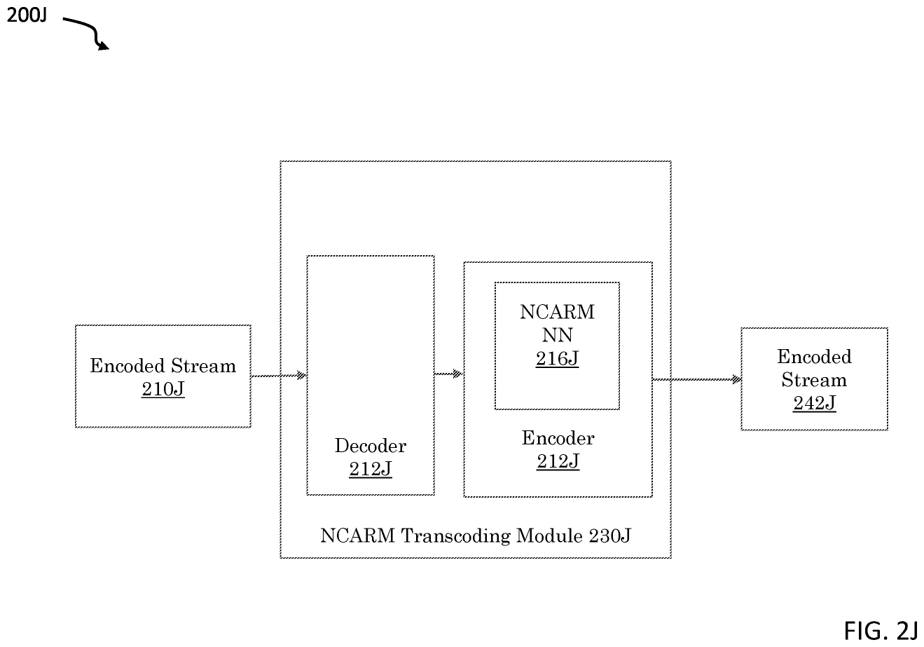

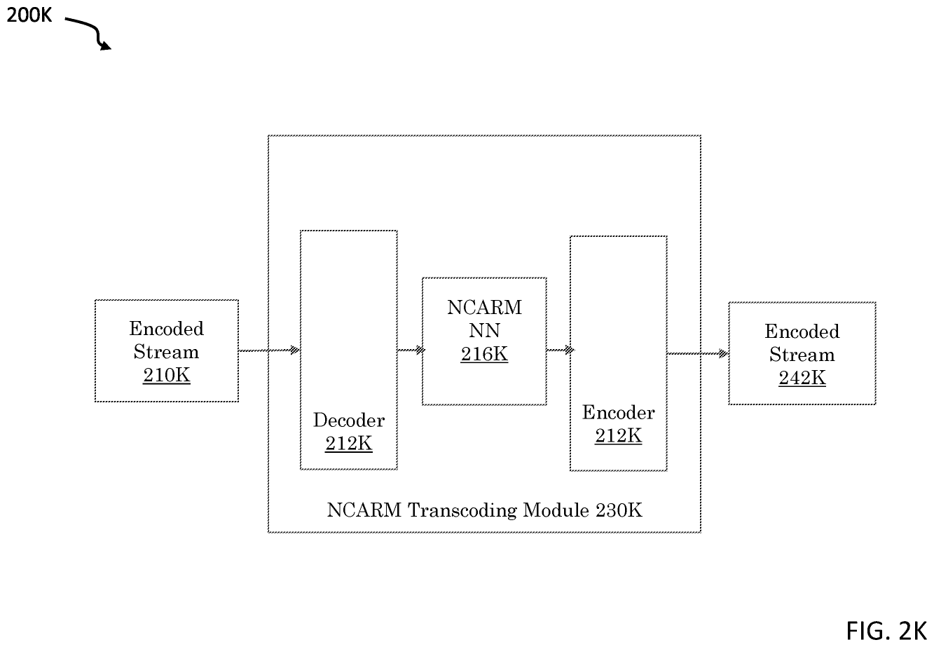

FIG. 2A illustrates a system and process 200A for neural network assisted compression artifact removal and calibration. As illustrated, data in the form of a high quality data stream 210A is provided to both an encoder 212A and an NCARM calibration module 220A. The encoded data stream from encoder 212A is provided to an NCARM transcoder 230. The NCARM transcoder 230A uses training and parameters specified by the NCARM calibration module 220A to decode data, process using module 216A that provides neural network mediated compression artifact removal and encodes the data with encoder 218A. Encoded data is supplied to decoder 240A, which can be converted to a decoded stream 242A, as well as fed back to the NCARM calibration module 220A to help improve long term system performance.

FIG. 2B illustrates a lossy compression system and process 200B for neural network assisted encoding and calibration. As illustrated, data in the form of a high quality data stream 210B is provided to both a lossy compression module 218B and an NCARM calibration module 220B. Within the lossy compression module 218B, the high quality data stream 210B is first provided to an NCARM encoder 216B and then a decoder 214B. The NCARM encoder 216B uses training and parameters specified by the NCARM calibration module 220B to decode data. Encoded data from the lossy compression module 218B is converted to a decoded stream 242B, as well as fed back to the NCARM calibration module 220B to help improve long term system performance.

FIG. 2C illustrates a lossy compression system and process 200C for neural network assisted decoding and calibration. As illustrated, data in the form of a high quality data stream 210C is provided to both a lossy compression module 218C and an NCARM calibration module 220C. Within the lossy compression module 218C, the high quality data stream 210B is first provided to an encoder 212C and then an NCARM decoder 214C. The NCARM encoder 214C uses training and parameters specified by the NCARM calibration module 220C to decode data. Encoded data from the lossy compression module 218C is converted to a decoded stream 242C, as well as fed back to the NCARM calibration module 220C to help improve long term system performance.

FIG. 2D illustrates a lossy compression system and process 200D for modifying high quality data streams using neural network assisted decoding and calibration. As illustrated, data in the form of a high quality data stream 210D is provided to a lossy compression module 218D. Additionally, data in the form of a high quality reference data stream 211D is provided to an NCARM calibration module 220D. Within the lossy compression module 218D, the high quality data stream 210D is first provided to an encoder 212D and then an NCARM decoder 214D. The NCARM encoder 214D uses training and parameters specified by the NCARM calibration module 220D to decode data. Encoded data from the lossy compression module 218D is converted to a decoded stream 242D, as well as fed back to the NCARM calibration module 220D to help improve long term system performance.

FIG. 2E illustrates a system and process 200E for neural network assisted decoding followed by neural network assisted compression artifact removal. As illustrated, data in the form of an encoded data stream 210E is provided to a NCARM decoding module 230E. Within the NCARM decoding module 230E, the encoded data stream 210E is first provided to a decoder 212E and then to an NCARM NN module 216E. Data from the NCARM decoding module 230E is converted to a decoded stream 242E.

FIG. 2F illustrates a decoder system and process 200F supporting neural network assisted compression artifact removal. As illustrated, data in the form of an encoded data stream 210F is provided to a NCARM decoding module 230F. Within the NCARM decoding module 230F, the encoded data stream 210F is first provided to a decoder 212F that supports an internal NCARM NN module 216F. Data from the NCARM decoding module 230F is converted to a decoded stream 242F.

FIG. 2G illustrates an encoder system and process 200G encompassing neural network assisted compression artifact removal. As illustrated, data in the form of an uncompressed data stream 211G is provided to a NCARM decoding module 230G. Within the NCARM decoding module 230G, the encoded data stream 211G is first provided to an encoder 212G that supports an internal NCARM NN module 216G. Data from the NCARM decoding module 230G is converted to an encoded stream 242G.

FIG. 2H illustrates an encoder system and process 200H encompassing neural network assisted compression artifact removal followed by encoding. As illustrated, data in the form of an uncompressed data stream 211H is provided to a NCARM decoding module 230H. Within the NCARM decoding module 230H, the uncompressed data stream 211H is first provided to an internal NCARM NN module 216H, followed by an encoder 212H. Data from the NCARM decoding module 230H is converted to an encoded stream 242H.

FIG. 2I illustrates a transcoding system and process 200I encompassing neural network assisted compression artifact removal and combined decoding, followed by encoding. As illustrated, data in the form of an encoded data stream 210I is provided to a NCARM transcoding module 230I. Within the NCARM transcoding module 230I, the encoded data stream 210I is first provided to a decoder 212I having internal NCARM NN module 216I, followed by an encoder 212I. Data from the NCARM transcoding module 230I is converted to an encoded stream 242I.

FIG. 2J illustrates a transcoding system and process 200J for decoding followed by neural network assisted compression artifact removal and combined encoding. As illustrated, data in the form of an encoded data stream 210J is provided to a NCARM transcoding module 230J. Within the NCARM transcoding module 230J, the encoded data stream 210I is first provided to a decoder 212J, followed by an encoder 212J having internal NCARM NN module 216J. Data from the NCARM transcoding module 230J is converted to an encoded stream 242J.

FIG. 2K illustrates a transcoding system and process 200A for decoding, followed by neural network assisted compression artifact removal, and separate encoding. As illustrated, data in the form of an encoded data stream 210K is provided to a NCARM transcoding module 230K. Within the NCARM transcoding module 230K, the encoded data stream 210K is first provided to a decoder 212K, followed by a NCARM NN module 216K and then an encoder 212K. Data from the NCARM transcoding module 230K is converted to an encoded stream 242K.

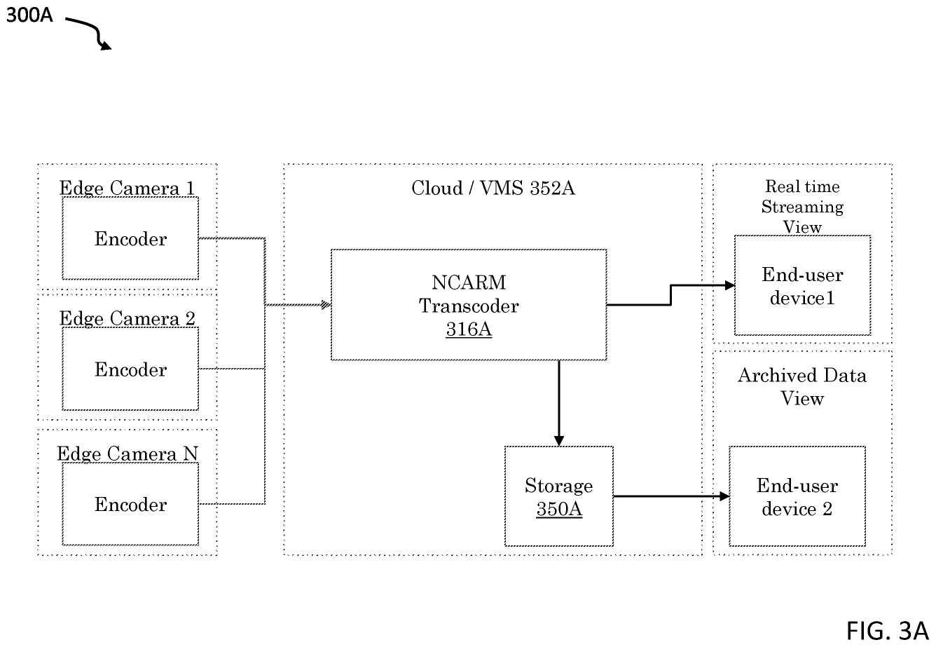

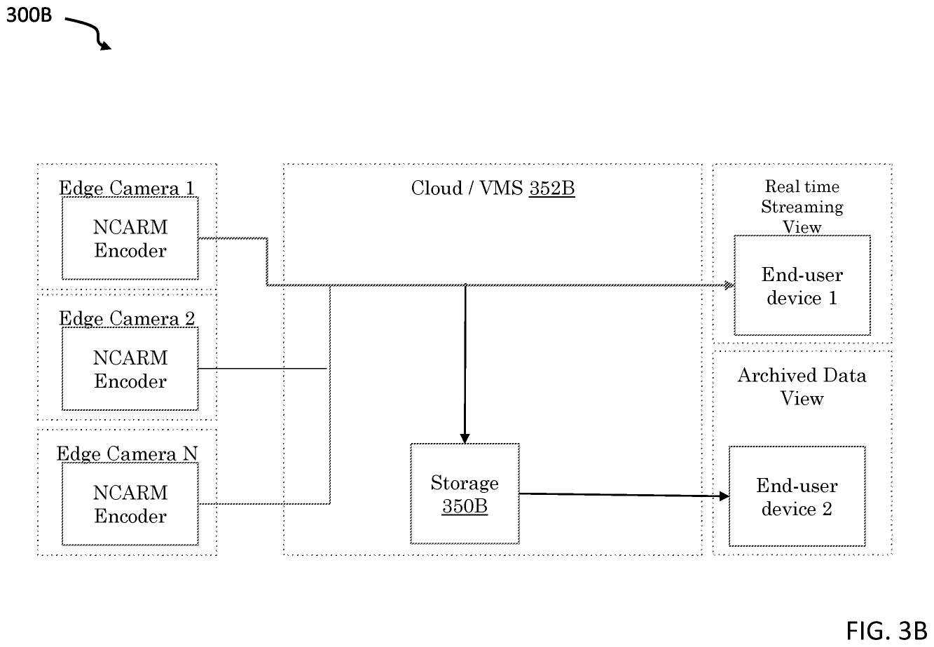

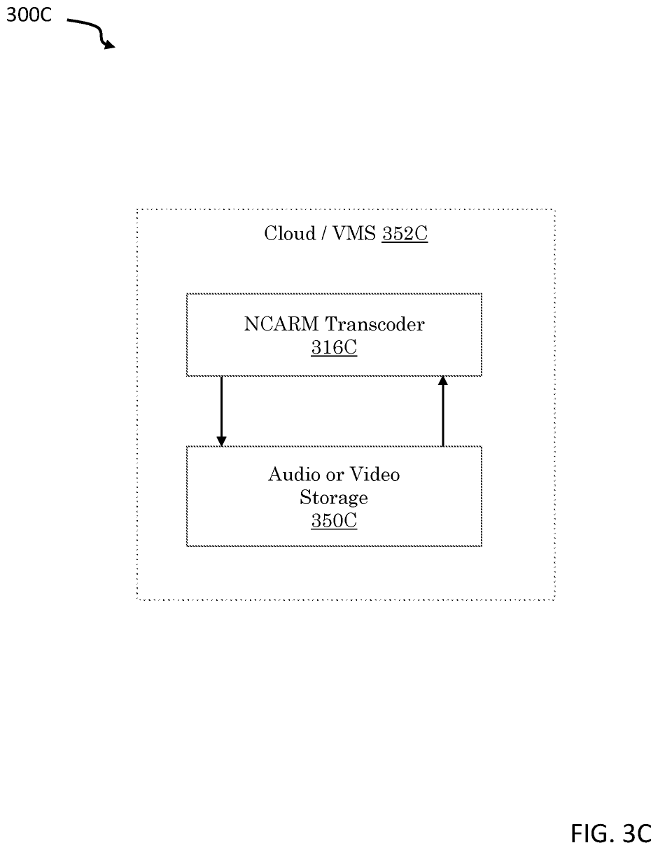

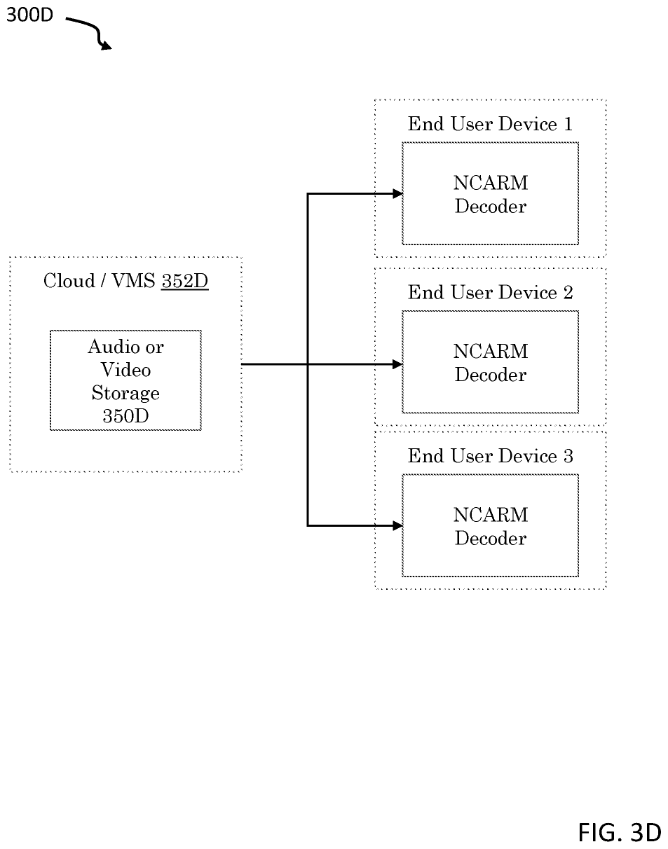

FIG. 3A illustrates a multiple camera system 300A supported by a transcoding system and process for neural network assisted compression artifact removal. As illustrated, a plurality of edge cameras (1, 2 . . . N) provide video and optional other data to a cloud/VMS system 352A. This data can be processed by encoder modules associated with the respective edge cameras. Incorporated within the cloud/VMS system 352A is a NCARM transcoding module 316A and connected storage 350A that receives data from the NCARM transcoding module 316A. As one alternative, data from the NCARM transcoding module 316A can be provided as real time streaming view to one or more end user devices. As another alternative, data from the storage 350A can be provided as an archived data view to one or more end user devices.

FIG. 3B illustrates a multiple camera system 300B, with each camera supported by a transcoding system and process for neural network assisted compression artifact removal. As illustrated, a plurality of edge cameras (1, 2 . . . N) provide video and optional other data to a cloud/VMS system 352B. This data can be processed by NCARM encoder modules associated with the respective edge cameras. Incorporated within the cloud/VMS system 352B is connected storage 350B. As one alternative, data from the NCARM modules from the edge cameras can be provided as real time streaming view to one or more end user devices. As another alternative, data from the storage 350B that was provided by NCARM modules from the edge cameras can also be provided as an archived data view to one or more end user devices.

FIG. 3C illustrates cloud system 300A including neural network assisted compression artifact removal encoding and decoding, and cloud storage. As illustrated, audio, video, or other compressible data provided to or incorporated within the cloud/VMS system 352C can be passed to a NCARM transcoding module 316C and connected storage 350C that receives data from the NCARM transcoding module 316A. This allows efficient conversion of lossy data between various audio or video compression schemes.

FIG. 3D illustrates a multiple user device system 300D, with each user device supported by a decoding system and process for neural network assisted compression artifact removal. As illustrated, data provided to or incorporated within the cloud/VMS system 352C can held in storage 350D. Audio, video, or other compressible data from the storage 350B can also be provided to one or more end user devices that include NCARM decoding capability.

As will be appreciated, a wide range of still or video cameras can benefit from use neural network supported image or video processing system and methods as discussed within this disclosure. Camera types can include but are not limited to conventional DSLRs with still or video capability, smartphone, tablet cameras, or laptop cameras, dedicated video cameras, webcams, or security cameras. In some embodiments, specialized cameras such as infrared cameras, thermal imagers, millimeter wave imaging systems, x-ray or other radiology imagers can be used. Embodiments can also include cameras with sensors capable of detecting infrared, ultraviolet, or other wavelengths to allow for hyperspectral image processing.

Cameras can be standalone, portable, or fixed systems. Typically, a camera includes processor, memory, image sensor, communication interfaces, camera optical and actuator system, and memory storage. The processor controls the overall operations of the camera, such as operating camera optical and sensor system, and available communication interfaces. The camera optical and sensor system controls the operations of the camera, such as exposure control for image captured at image sensor. Camera optical and sensor system may include a fixed lens system or an adjustable lens system (e.g., zoom and automatic focusing capabilities). Cameras can support memory storage systems such as removable memory cards, wired USB, or wireless data transfer systems.

In some embodiments, neural network processing can occur after transfer of audio, video, or other compressible data to a remote computational resources, including a dedicated neural network processing system, laptop, PC, server, or cloud. In other embodiments, neural network processing can occur within the camera, using optimized software, neural processing chips, dedicated ASICs, custom integrated circuits, or programmable FPGA systems.

As will be understood, the camera system and methods described herein can operate locally or in via connections to either a wired or wireless connect subsystem for interaction with devices such as servers, desktop computers, laptops, tablets, or smart phones. Data and control signals can be received, generated, or transported between varieties of external data sources, including wireless networks, personal area networks, cellular networks, the Internet, or cloud mediated data sources. In addition, sources of local data (e.g. a hard drive, solid state drive, flash memory, or any other suitable memory, including dynamic memory, such as SRAM or DRAM) that can allow for local data storage of user-specified preferences or protocols. In one particular embodiment, multiple communication systems can be provided. For example, a direct Wi-Fi connection (802.11b/g/n) can be used as well as a separate 4G cellular connection.

Connection to remote server embodiments may also be implemented in cloud computing environments. Cloud computing may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

The flow diagrams and block diagrams in the described Figures are intended to illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A data compression system, comprising:
a neural compression artifact removal module (NCARM) arranged to receive compressible data and output data with compression artifacts removed;
a lossy compression module arranged to at least one of receive and send data to the NCARM; and
a decompression module arranged to at least one of receive and send data to the NCARM.

2. The data compression scheme of claim 1, wherein the NCARM sends data to the lossy compression module.

3. The data compression scheme of claim 1, wherein the NCARM receives data from the decompression module.

4. The data compression scheme of claim 1, wherein the NCARM receives data from the lossy compression module.

5. The data compression scheme of claim 1, wherein the data is at least one of audio and video.

6. A data compression system, comprising:
a neural compression artifact removal module (NCARM) forming a portion of at least one of a transcoder and a lossy compression module, with the NCARM arranged to receive compressible data and output data with compression artifacts removed; and
a data encoder and decoder respectively connected to the NCARM;
a NCARM calibration module arranged to at least one of receive and send data to the NCARM.

7. The data compression system of claim 6, wherein the lossy compression module receives high quality streaming data.

8. The data compression system of claim 6, wherein the NCCARM calibration module receives high quality reference streaming data.

9. The data compression system of claim 6, wherein the lossy compression module outputs decoded streaming data.

10. The data compression scheme of claim 6, wherein the data is at least one of audio and video.

11. A data compression system, comprising:
a neural compression artifact removal module (NCARM) forming a portion of at least one of a transcoder, a lossy compression module, an encoding module, and a decoding module, with the NCARM arranged to receive compressible data and output data with compression artifacts removed; and
a data encoder and decoder respectively connected to the NCARM; and wherein a NCARM neural network forms a portion of one of the data encoder and decoder.

12. The data compression system of claim 11, wherein the lossy compression module receives encoded stream data.

13. The data compression system of claim 11, wherein the NCCARM calibration module receives uncompressed stream data.

14. The data compression system of claim 11, wherein the lossy compression module outputs at least one of encoded and decoded streaming data.

15. The data compression scheme of claim 11, wherein the data is at least one of audio and video.

16. A camera data compression system, comprising:
a camera;
a neural compression artifact removal module (NCARM) connected to the camera and arranged to receive compressible data and output data with compression artifacts removed.

17. The camera data compression scheme of claim 16, wherein the NCARM is operable on the camera.

18. The camera data compression scheme of claim 16, wherein the NCARM is operable on a cloud/VMS system that receives compressible data from the camera.
